(19) United States
(12) Patent Application Publication
(10) Pub. No.: US 2020/0047894 A1
(43) Pub. Date: Feb. 13, 2020

(54) Extended Drone Range

(71) Applicant: Jocelyn Bruno, Cibolo, TX (US)

(72) Inventor: Jocelyn Bruno, Cibolo, TX (US)

(21) Appl. No.: 16/660,245

(22) Filed: Oct. 22, 2019

(51) Int. Cl. B64D 27/20; B64C 39/02; B64D 7/08; B64D 1/02; F41F 3/06; G05D 1/10

(52) U.S. Cl. CPC B64D 27/20; B64C 39/024; B64D 7/08; B64C 2201/167; F41F 3/06; G05D 1/101; B64D 1/02

(57) ABSTRACT

This disclosure generally relates to the use of solid fuel rockets with drone aircraft. Solid fuel tanks can be mounted to a Drone, for example, the underside of the drone. They may be built similar to guided missiles and once they complete their task they may detach from the drone and, in embodiments, equipped with all components found on guided missiles, i.e., guidance Section, control section, wings and fins, they may return to point of origin. In other embodiments, they may be deployed as missiles or remain attached to the drone.

### BACKGROUND OF THE DISCLOSURE

### Field of the Invention

This disclosure is generally directed to drones and can also be applied to manned military aircraft, and methods to extend the range of such aircraft through the use of solid Rocket Fuel Rocket systems.

### Description of the Related Art

Drone aircraft generally fly from the point of origin to a destination point with engines running continuously throughout flight to the point of destination. Methods of extending drone range are needed.

### SUMMARY OF THE INVENTION

This disclosure generally relates to the use of solid fuel rockets with drone aircraft. Solid fuel tanks can be mounted to a drone, for example, the underside of a drone. They may be built similar to guided missiles and once they complete their task they may detach from the drone and, in embodiments, equipped with all components found on guided missiles, i.e., a guidance section, a control section, wings, and fins, they may return to the vicinity of the point of origin or some other location. In other embodiments, they may remain attached to the drone and be deployed as missiles.

Other features and aspects will be apparent from the following detailed description, the drawings, and the claims

### BRIEF DESCRIPTION OF THE DRAWINGS

FIG. 1 shows one embodiment of a view of a drone with solid fuel rockets attached.

FIG. 2 shows one embodiment of a close-up view of a solid fuel rocket of the invention.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

Solid fuel tanks can be mounted to a drone, for example, to the underside of the drone. It is noted that in addition to the solid fuel tanks the drone may have its own separate engines. The solid fuel tank may be an add-on to a fully operational drone or manned aircraft with its own fuel tanks. In one embodiment, the solid fuel tanks are similar to guided missiles and once they complete their task, they may detach from the drone and, in embodiments, equipped with all components found on guided missiles, i.e., a guidance section, control section, wings, and fins, they may return to the vicinity of the point of origin. A control system may then turn off the rockets and deploy parachutes so the reusable solid fuel rockets can descend to land or sea where they can be recovered for reuse. Reusable solid fuel rockets may significantly increase drone range because they can ignite simultaneously and continue burning to provide takeoff power, they may continue burning after takeoff and power drone to achieve cruising speed and altitude, and may continue burning until there remains only enough fuel for the return journey to, for example, the point of origin.

In other embodiments, solid fuel tanks offer further options. For example, solid fuel tanks may not detach and return to point of origin, they may remain attached to the drone throughout flight. For example, in one embodiment, drone range is extended by solid fuel rockets by providing takeoff power, power to achieve cruising altitude, and cruising speed, and unless turned off, continue burning until expendable fuel is exhausted, at which point, drone engines are turned on, and solid fuel tanks remain attached to the drone and can then be missiles that can be deployed.

In another example, perhaps suitable for reconnaissance missions, solid fuel tanks do not ignite initially. At higher altitudes where air is too thin for jet engines or propeller driven Drones, solid fuel tanks are turned on, and drones engines turned off, providing drones with further capability to fly at higher altitudes nearing space. Drones may return to altitude where jet engines are able to perform before expendable fuel tank is exhausted. Once expendable fuel is exhausted, drone engines are turned on and solid fuel tanks are now missiles that can be deployed.

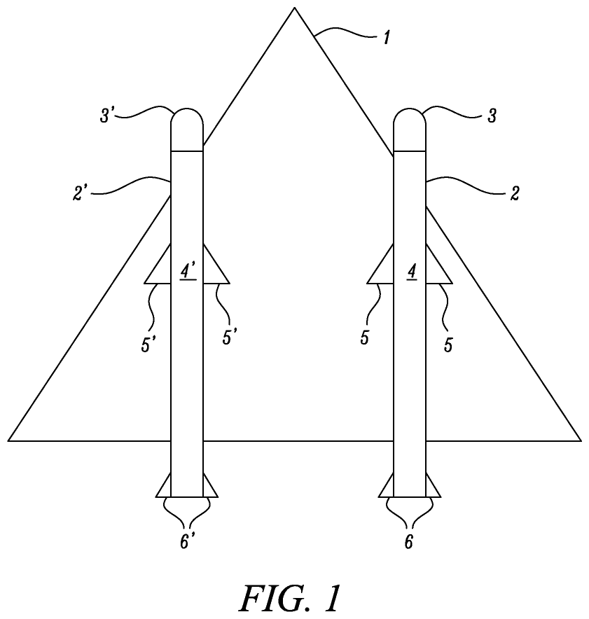

FIG. 1 shows a view of a drone 1 with two solid fuel rockets 2, 2′, mounted, in one embodiment, to the underside of drone 1. FIG. 1 further shows each solid fuel rocket 2, 2′ includes guidance sections 3, 3′, a solid fuel core 4, 4′, a control section\wings 5, 5′ and fins 6, 6′ on each solid fuel rocket 2, 2′.

As mentioned, after exhausting all the expendable solid fuel except for an amount necessary for journey back to the point of origin, solid fuel tanks 2, 2′, may separate from drone 1. In this case, the solid fuel tanks 2, 2′, may now be flying in the same manner as a missile. Guidance system 3, 3′ would then navigate solid fuel rockets to a safe location, for example, in the vicinity of point of origin where control section 5, 5′ shuts down rocket power and deploys a parachute (not shown).

Solid fuel rockets 2, 2′, may be built similar to missiles with one optional difference being that rather than having an armament section they contain solid fuel. Such systems may be used on both jet propelled aircraft or propeller driven aircraft. Drone range may be significantly increased because the solid fuel rocket powers take off, achieving altitude, and cruising speed, and may cover the majority of distance to destination.

The solid fuel tanks 2, 2′, may be securely mounted to the drone aircraft 1. Solid fuel rockets 2, 2′, may ignite simultaneously and power the drone for takeoff. The solid fuel rockets may continue burning until a sensing unit in the rockets guidance system 4 determines remaining rocket fuel is just enough for a return trip, for example, to the point of origin. At this point, the drone turns on its own engines, the rockets separate from the drone, and change course to return. Upon arriving, for example, in the vicinity of point of origin, the rocket shuts down and deploys a parachute to land on sea or land. The reusable rocket may then be recovered.

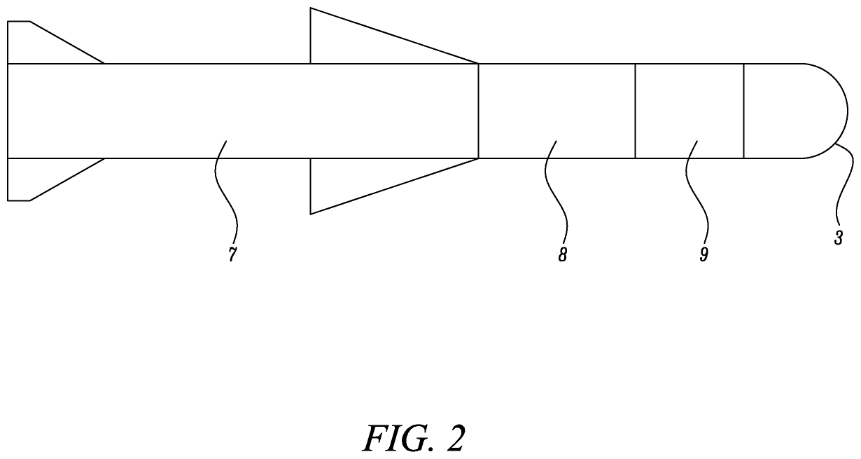

FIG. 2 shows a close-up view of a solid fuel tank 2. Solid fuel tank 2 includes expendable fuel 7, fuel reserved for missile use (perhaps 20%) 8, armament compartment 9, and guidance system 3. Expendable fuel is an amount of fuel used for flying the drone not including an amount of fuel reserved for missile use.

Solid fuel tanks 2 may offer several possible options. In one option, solid fuel tanks remain attached to the aircraft unless deployed as a missile. It should be noted that, at any point in flight, solid fuel tank 2 may be launched as a missile. In one option, drone range is extended with the solid fuel rocket providing takeoff power, power to achieve cruising altitude, and cruising speed and continues burning until expendable fuel is exhausted. At this point, solid fuel tank 2 can be a missile which can be deployed.

In another option, the solid fuel tank does not ignite initially. At higher altitudes, the drone engines can be turned off and solid fuel tanks can be turned on providing drones with the ability to fly at higher altitudes where the air is too thin for jet engines or propeller driven drone. In this embodiment, when expendable fuel is exhausted, solid fuel tank may now be used as a missile which can be deployed.

While this disclosure includes specific examples, it will be apparent after an understanding of the disclosure of this application has been attained that various changes in form and details may be made in these examples without departing from the spirit and scope of the claims and their equivalents.

What is claimed is:

1. A drone aircraft comprising:
engines; and
one or more solid fuel rockets.

2. The drone aircraft of claim 1, wherein the one or more solid fuel rockets comprise:
a guidance section;
a solid fuel core,
a control section including wings, and
fins.

3. The drone aircraft of claim 2, wherein the one or more solid fuel rockets further comprises:
a section for expendable fuel;
a section for fuel reserved for missile use; and
an armament compartment.

4. The drone aircraft of claim 1, wherein the one or more solid fuel rockets are attached to the underside of the drone aircraft.

5. The drone aircraft of claim 1, wherein there are two solid fuel rockets.

6. A method of flying the drone aircraft of claim 1, comprising:
launching the drone using the solid fuel rockets;
flying the drone aircraft some distance using the solid fuel rockets.

7. The method of claim 6, wherein the solid fuel rockets power the drone until all expendable solid fuel is used.

8. The method of claim 7, wherein the solid fuel rockets are deployed as missiles.

9. The method of claim 6, further comprising:
detaching the solid fuel rockets from the drone after the flying of some distance and turning on the drone engines;
returning the solid fuel rockets to the vicinity of the point of origin, or some other location, for re-use.

10. The method of claim 9, wherein the solid fuel rockets return to the vicinity of the point of origin for re-use.

11. The method of claim 9, wherein the solid fuel rockets fly the drone until approximately sufficient solid rocket fuel remains to return the solid fuel rockets to the vicinity of the point of origin.

12. A method of flying the drone aircraft of claim 1, comprising:
launching the drone using the drone engines;
flying the drone some distance;
turning on the solid fuel rockets and turning off the drone engines.

13. A method of flying the drone aircraft of claim 12, further comprising:
flying the drone with the solid fuel rockets until all expendable solid fuel has been used.

14. The method of claim 13, wherein the solid fuel rockets are deployed as missiles.
